(19) United States
(12) Patent Application Publication
(10) Pub. No.: US 2026/0252460 A1
(43) Pub. Date: Aug. 27, 2026

(54) RESOURCE MANAGEMENT FOR TRAINING MACHINE LEARNING MODELS

(71) Applicant: Microsoft Technology Licensing, LLC, Redmond, WA (US)

(72) Inventors: Ana-Maria CONSTANTIN, Seattle, WA (US); Raphael GHELMAN, Kirkland, WA (US); Pulak GOYAL, Fremont, CA (US)

(21) Appl. No.: 18/726,406

(22) PCT Filed: Feb. 3, 2023
(86) PCT No.: PCT/US2023/062006

§ 371 Date: Jul. 2, 2024

(30) Foreign Application Priority Data
Feb. 4, 2022 (NL) 2030823

(51) Int. Cl. G06F 11/34; G06F 9/50

(52) U.S. Cl. CPC G06F 11/3419; G06F 9/5072; G06F 11/3452

(57) ABSTRACT

A system and method for managing resources for training machine learning (ML) models is described. A processor collects time-series data corresponding to an interval of time, generates a partitioning schema file for the collected time-series data, partitions the collected time-series data according to the partitioning schema file based on metadata characteristics of the time-series data, and transmits the partitioned time-series data and the partitioning schema file to a storage device. The processor further assigns a plurality of worker nodes to the partitioned time-series data based at least in part on the partitioning schema file stored in the storage device. The worker nodes reconstruct a sequence of time-series data for a plurality of intervals of time from the storage. The intervals include the partitioned time-series data and the previous intervals of time-series data. The worker nodes train, in parallel, a ML model using the reconstructed sequence of time-series data.

### BACKGROUND

Forecasting, statistical analysis, and other data analysis systems benefit from regularly updated data, as the systems evolve and as new data becomes available. However, with existing systems, significant processing and storage capacity is required to collect and process data at frequent intervals, to enable recalibration, retraining, or updating of the systems. The processing and storage requirements, along with management of these resources, is significant and can have a negative effect on the performance of these systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system for performing a rolling window data and time-series training is provided. The example system includes at least one processor and at least one memory comprising computer program code. The computer program code, when executed by the at least one processor, causes the at least one processor to collect time-series data corresponding to an interval of time, generate a partitioning schema file for the collected time-series data, partition the collected time-series data according to the partitioning schema file based on metadata characteristics of the time-series data, transmit the partitioned time-series data and the partitioning schema file to a storage device, the storage device storing time-series data collected during previous intervals of time, assign a plurality of worker nodes to the partitioned time-series data based at least in part on the partitioning schema file stored in the storage device, reconstruct, by the assigned plurality of worker nodes, a sequence of time-series data for a plurality of intervals of time from the storage device, the plurality of intervals including the partitioned time-series data and the time-series data collected during the previous intervals of time, and train, by the assigned plurality of worker nodes in parallel, a machine learning (ML) model using the reconstructed sequence of time-series data.

### BRIEF DESCRIPTION OF THE DRAWINGS

The present description will be better understood from the following detailed description read in light of the accompanying drawings, wherein:

FIG. 1 is a block diagram illustrating a system for performing rolling window data transfers for time-series training;

FIG. 2 illustrates an example histogram generated based on the results of the collected data;

FIG. 3 illustrates a cluster including one or more nodes;

FIG. 4 illustrates a rolling window data collection folder structure;

FIG. 5 illustrates another rolling window data collection folder structure;

FIG. 6 illustrates a method for performing a rolling data transfer and time-series training; and

FIG. 7 illustrates an example computing apparatus as a functional block diagram.

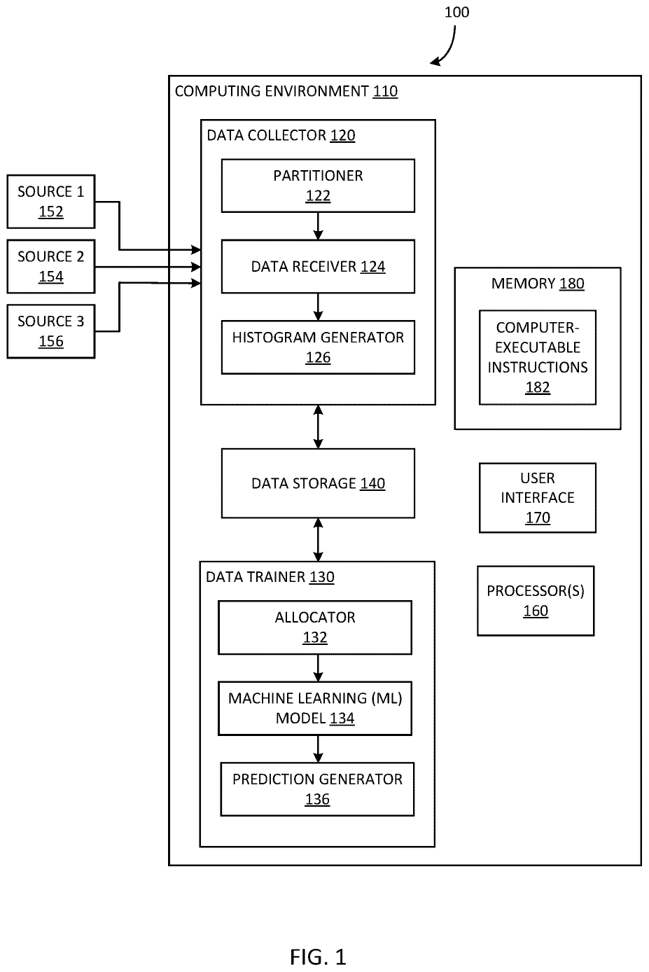

Corresponding reference characters indicate corresponding parts throughout the drawings. In FIGS. 1 to 7, the systems are illustrated as schematic drawings. The drawings may not be to scale.

### DETAILED DESCRIPTION

The systems and methods presented herein address various problems presented by conventional solutions performing time-series analysis at scale for large datasets. For example, data sets can contain hundreds of thousands or millions of components that must be included in modeling for generating predictions. In these situations, it is difficult to train the data for each component, build a model, and effectively forecast. These challenges are particularly evident in scenarios such as ones where forecasting must be updated at regular time intervals, statistical analyses where the data changes with time and results are recalibrated accordingly, and productionized machine learning models that are trained on past data that need to be updated and retrained as systems evolve and new data is collected. Current solutions intended to address this problem require significant costs and resources, including processing power, storage capacity, network bandwidth, and time at least due to the repetitive operation of downloading and processing the past data.

Aspects of the disclosure provide a computerized method and system for a rolling window data transfer for time-series training. Examples of the disclosure perform data processing sequentially using a rolling window mechanism for streaming batch processing to execute increasingly complex time-dependent experiments, while minimizing costs for the platform provider. The example system includes at least one processor and at least one memory comprising computer program code. The computer program code, when executed by the at least one processor, causes the at least one processor to perform operations. In some examples, some of the operations are described as being performed by a first agent and a second agent. However, the operations may be performed by a single agent, or a configuration of any quantity of agents performing any of the operations.

In some examples, a first agent implemented on the processor collects or otherwise receives time-series data corresponding to an interval of time. The first agent generates a partitioning schema file for the collected time-series data. The first agent partitions the collected time-series data according to the partitioning schema file based on metadata characteristics of the time-series data. The first agent transmits the partitioned time-series data and the partitioning schema file to a storage device. The storage device stores time-series data collected during previous intervals of time.

The second agent is also implemented on the same processor as the first agent, or another processor. The second agent assigns a plurality of worker nodes to the partitioned time-series data based at least in part on the partitioning schema file stored in the storage device. The assigned plurality of worker nodes reconstructs a sequence of time-series data for a plurality of intervals of time from the storage device. The plurality of intervals includes the partitioned time-series data and the time-series data collected during the previous intervals of time The assigned plurality of worker nodes trains, in parallel, a machine learning (ML) model using the reconstructed sequence of time-series data.

The system provided in the present disclosure operates in an unconventional manner at least by downloading new time-series data using a rolling window technique that utilizes a set of worker nodes (or other processing units or entities) running in parallel in a low-cost environment on a regular cadence to fetch and persist new streams in a secure, low-cost, intermediary storage environment. The incoming data is partitioned using a partitioning schema file that includes metadata characteristics to enable efficient, well-balanced distributed processing by a training environment that is decoupled from the data collection environment. In the training environment, the set of worker nodes are assigned, or allocated, based on the partitioning schema file, and the worker nodes reconstruct the time-series data by appending consecutive sequences of downloaded, rolling window data for parallelized training.

Aspects of the present disclosure provide technical solutions to the technical problems identified and described herein at least by providing systems and methods that perform time-series parallelized data collection and processing in a low memory environment. New data is generated using a rolling window technique and persisted in a remote, intermediary storage using a combination of metadata characteristics to partition incoming streams for optimal parallel processing, and minimize costs during training. More particularly, the rolling window technique collects only the time-series data from windows that have not been previously downloaded, partitions the incoming data, and reports the details of the partitioning in order for a training environment to optimally perform parallelized training such that nodes and their respective worker nodes can be efficiently allocated for training and generation of improved predictions and forecasts based on the training. This technical solution provides multiple technical solutions, such as improved resource management and processing performance due to avoiding the download of overlapping data, improved computational speed for data collection due to worker nodes only needing to download small chunks of data, a reduction in network traffic, a reduction of needed storage resources, the ability to run more complex models during training with increased accuracy, enhancements in performance, and a reduction of platform costs.

As described herein, implementations of the present disclosure decouple the data collection environment and the data training environment. This enables, among other advantages, an optimization of resource configuration for the data collection and training independently, which maximizes performance and minimizes cost at least because large volume time-series training and forecasting across a minimal or reduced number of virtual machines (VMs) in a distributed, highly parallelized manner is possible. In contrast to current solutions, which are less efficient and more costly, implementations of the present application leverage the time series nature of the incoming data. This further enables, in some examples, a simple directory structure to be used as an intermediary data storage to store the incoming data between the data collection operation and the data training operation. By using an intermediary data storage, the data collection environment can write to the remote storage without reshuffling data and the data training environment can download all of the relevant data in a parallelized manner.

In some examples, rolling window data transfer refers to the process of incrementally downloading windows of data. For example, where a past thirty days of data are required for training and data collection is performed every hour, a rolling window data transfer downloads and stores only the data that has not been previously downloaded and stored, such as the data generated after the most recent transfer. In this manner, a minimum amount of network and system resources are utilized, enabling performance of the system.

Machine learning models include a predictor, in some examples. A predictor utilizes historical data or outcomes to predict or infer a future outcome. ML models can further include one or more of a classifier, an encoder, or a decoder in addition to or instead of a predictor. Classifiers utilize ML models to distinguish and classify data into a particular classification, or category. An encoder converts numerical data into categorical data. Decoders, in contrast, convert categorical data into numerical data. In some implementations, the ML models described herein can further utilize deep learning, such as neural networks like artificial neural networks (ANNs), or natural language processing (NLP) for processing and training of data.

In some implementations, the training described herein based on the collected data is used by one or more systems to generate a prediction or forecast for future iterations of the collected data. For example, where the collected data refers to a percentage of central processing unit (CPU) processing power historically utilized, the prediction or forecast refers to a predicted amount of CPU processing power expected to be utilized at a future point in time based at least in part on the past collected data. In another example, where the collected data refers to weather data, the prediction or forecast refers to a weather forecast based at least in part on the past collected data. However, it should be understood that these examples are provided for illustration only and should not be construed as limiting. Various predictions and/or forecasts can be generated by a trained ML model as described herein.

FIG. 1 is a block diagram illustrating a system for performing rolling window data transfers for time-series training. The system 100 is provided for illustration only and should not be construed as limiting. Various implementations of the system 100 are possible. For example, additional components can be added, components can be removed, and so forth without departing from the scope of the present disclosure.

The system 100 includes a computing environment 110. The computing environment 110, in some examples, includes a mobile computing device or any other portable device. A mobile computing environment 110 includes, for example but without limitation, a mobile telephone, laptop, tablet, computing pad, netbook, gaming device, wearable device, Internet of Things (IOT) device, and/or portable media player. The computing environment 110 can also include less-portable devices such as servers, desktop personal computers, kiosks, IoT devices, or tabletop devices. Additionally, the computing environment 110 can represent a group of processing units or other computing devices. In some examples, the computing environment 110 is a device executed in the cloud. The computing environment 110 includes a data collector 120, a data trainer 130, and a data storage 140.

In some implementations described herein, the data collector 120 and the data trainer 130 are decoupled within the computing environment 110 with the data storage 140 utilized as an intermediary. For example, to implement the data collection operation and the data training operation, the data collector 120 and the data trainer 130 run independently from each other: (i) as separate threads or processes, (ii) on separate devices, (iii) without communication between each other, and/or (iv) by separate entities. The data collector 120 and the data trainer 130 each access the data storage 140 to store and retrieve, respectively, the collected data as described herein.

The data collector 120 executes a data collection environment and includes a partitioner 122 (e.g., a partitioning module, component, or apparatus), a data receiver 124 (e.g., a data collection or receiver module, component, or apparatus), and a histogram generator 126 (e.g., a histogram generating module, component, or apparatus). In some examples, the data collector 120 is referred to as an agent, such as a first agent. In some examples, an agent includes logic, instructions, or other operations performed The partitioner 122 generates a partitioning schema file for incoming data received by the data receiver 124. The partitioning schema file is a file storing a scheme, or plan, for storing the incoming data in the data storage 140 upon receipt by the data receiver 124.

In some implementations, the partitioner 122 partitions the incoming data based on metadata characteristics of the incoming data. The metadata characteristics can include one or more of an interval (e.g., slot) of time or a predicted granularity of a rolling window of time. The interval of time can be a rolling window of time, for example a particular window of the rolling window described in greater detail below. In some implementations, the partitioner 122 partitions the incoming data based on a source, of the one or more sources 152, 154, 156, of the incoming data, in addition to or instead of the metadata characteristics.

In some implementations, the partitioner 122 generates the partitioning schema file prior to receiving the incoming data. For example, the partitioner 122 can generate the partitioning schema file by estimating quantities of the incoming data and preemptively prepare for how the incoming data will be stored in the data storage 140. In other implementations, the partitioner 122 generates the partitioning schema file in real-time as the incoming data is received by the data receiver 124. For example, as the data receiver 124 receives the incoming data, the partitioner 122 identifies a source of particular aspects of the data and generates the partitioning schema file accordingly.

The data receiver 124 receives incoming data. As illustrated in FIG. 1, the data receiver 124 receives incoming data from three different sources, source 1 152, source 2 154, and source 3 156. However, it should be understood that sources 152, 154, 156 are provided for illustration only and should not be construed as limiting. Incoming data can be received from more or fewer than three sources without departing from the scope of the present disclosure. The incoming data can be any type of data, for example historical percentages of central processing unit (CPU) processing storage utilized, memory utilized, incoming traffic, database activity, network information, incoming and outgoing requests, weather data including temperature, precipitation, and so forth, and screen time of a mobile device. In some implementations, the incoming data is data associated with a quantity of identifiers (IDs) collected from one or more sources. For example, the ID can be a service set identifier (SSID), a globally unique identifier (GUID), a VM ID, a serial number, a private key, or any other suitable type of identifier that is associated with data.

The received incoming data is associated with the particular source from which it was received. In some implementations, the partitioner 122 partitions the incoming data such that the incoming data from specific sources are stored together by the data storage 140. For example, the incoming data received from source 1 152 is stored together, the incoming data received from source 2 154 is stored together, and incoming data received from source 3 156 is stored together.

In some implementations, the data receiver 124 receives the incoming data by a rolling window data transfer. As referenced herein, rolling window data transfer refers to the process of incrementally downloading data associated with particular windows of time. For example, the data trainer 130, described in greater detail below, trains using datasets of specific size, such as the most recent thirty days. As time passes, the most recent thirty days changes. By incrementally downloading windows of data, data for the most recent period of time can continually be received for use by the data trainer 130.

In the example above, data corresponding to the most recent thirty days is used by the data trainer 130 for training. In some implementations, the rolling window data transfer is executed at every hour. So, in a first iteration of data collection, for example at 1:00 PM, the data receiver 124 queries the source and downloads the past thirty days of data to be used for training by the data trainer 130. By 2:00 PM, i.e., one hour after the first iteration of data collection and in the next interval for data collection, a majority of the most recent thirty days of data has already been collected by the data receiver 124, but data corresponding to the window of 1:00 PM to 2:00 PM has not been downloaded. Therefore, at the 2:00 PM data collection, the data receiver 124 queries the source for only data for the window between 1:00 PM and 2:00 PM, which has not been previously downloaded. Then, the received data for the particular window is stored by the data storage 140 according to the partitioning schema file and is used by the data trainer 130 for training.

It should be understood that although a window of one hour is described herein for ease of illustration, various implementations are possible. The window can correspond to any suitable schedule for data transfer and training without departing from the scope of the present disclosure. In some implementations, the data receiver 124 dynamically adjusts the length of the window based on calculated accuracy of the predictions or forecasts generated by the data trainer 130. For example, the computing environment 110 includes a feedback loop that includes generating the predictions or forecasts by the data trainer 130, measuring an accuracy of the predictions or forecasts, and providing feedback to the data collector 120. In such examples, based on a high accuracy of the predictions or forecasts, the data collector 120 determines to maintain or extend the window for the rolling window data transfer such that additional resources are not utilized to generate the prediction or forecast. In another example, based on a low accuracy of the predictions or forecasts, the data collector 120 determines to shorten the window for the rolling window data transfer to improve the accuracy of the prediction or forecast.

By utilizing a rolling window data transfer, rather than downloading the full dataset each time, the data collector 120 provides several advantages. For example, overlapping data is not downloaded at every iteration and the runtime of a pipeline is reduced, which provides flexibility to increase the lookback time and allow the data trainer 130 to make more informed predictions or forecasts by enabling the training of multiple models and choosing the most accurate one. Utilizing the rolling window data transfer further reduces the size of data that is written to the intermediate storage, e.g., the data storage 140, because less data is downloaded for processing.

In some implementations, the data receiver 124 receives the incoming data files and compresses the received data into a compressed file (e.g., a . zip file). The compressed file can be stored in the data storage 140 and then decompressed by a VM that is allocated to the ID associated with the particular data file. By storing a compressed file rather than a non-compressed version of the file, the data collector 120 minimizes the amount of bandwidth and storage space required to store the file, the amount of bandwidth required to extract the file, and the time required for the data trainer 130 to receive the file.

Accordingly, to complete the data collection, the data receiver 124 populates partial hour data, populates complete hour data, backfills data, and writes worker assignment files. Returning to the example above where data corresponding to the most recent thirty days is used by the data trainer 130 for training, the present disclosure contemplates a scenario where a source or sources respond to a query for updated data at 2:15 PM. The received incoming data will include only a partial hour of data, for example 2:00 PM to 2:14 PM. In this example, the data receiver 124 collects the received incoming data, compresses the received data into a compressed file, and transfers the compressed file to a partial hours' folder in the data storage 140 for short-term storage.

At the next interval of the rolling window, e.g., 3:00 PM, the data receiver 124 queries the source for the complete hour of data. In some implementations, the source returns a complete hour of data for the rolling window of 2:00 PM to 3:00 PM, which includes the partial hour data stored already. The data receiver 124 backfills the missing data by receiving, compressing, and storing the complete hour of data within the data storage 140 as described herein and recycles the partial hour of data. In other implementations, the source returns a partial hour of data including the data not already returned to the data receiver 124, i.e., from 2:14 PM to 3:00 PM. The data receiver 124 receives, compresses, zips, and stores the second partial hour of data within the data storage 140 as described herein and the data trainer 130, described in greater detail below, appends the second partial hour of data, corresponding to 2:14 to 3:00, to the first partial hour of data, corresponding to 2:00 to 2:14, to reconstruct a complete hour of incoming data.

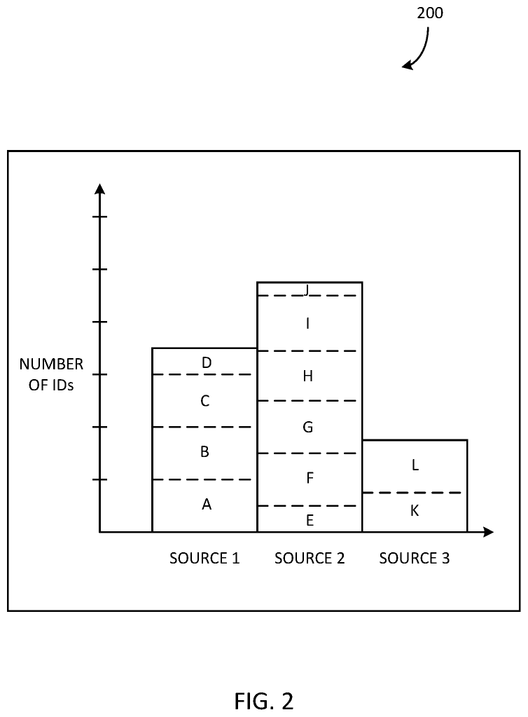

The histogram generator 126 generates a histogram, for example the histogram 200 illustrated in FIG. 2, that indicates the partitioning of the received incoming data stored by the data storage 140. The histogram 200 identifies a quantity, or approximate quantity, of IDs for which incoming data was received from each particular source in a particular rolling window. The histogram 200 can be utilized by, for example, the data trainer 130 to allocate VMs, also referred to herein as workers or worker nodes, to particular subsets of the received incoming data in order for the data training step to be performed optimally and most efficiently. While some examples are described with reference to a histogram, aspects of the disclosure are operable with any data structure for indicating the partitioning of the received incoming data stored by the data storage 140.

As illustrated in FIG. 2, the histogram 200 illustrates a number of IDs on the y-axis and different sources of the incoming data on the x-axis. In this manner, the histogram 200 illustrates a number of IDs received from each source, such as the source 1 152, the source 2 154, and the source 3 156. The number of IDs can be provided in any suitable increment, for example increments of ten, increments of one hundred, increments of one thousand, and so forth. For example, where the number of IDs in the histogram 200 are provided in increments of one hundred, each block A-L illustrated in the histogram is representative of 100 IDs. As illustrated in FIG. 2, source 1 152 includes 350 IDs receiving in the incoming data. These IDs are illustrated by blocks A-D, where each of blocks A-C represent 100 IDs and block D represents fifty IDs, as evidenced by the number of IDs denoted by the y-axis. Source 2 154 includes 475 IDs, where block E represents fifty IDs, each of blocks F-I represent 100 IDs, and block J represents twenty-five IDs. Source 3 156 includes 175 IDs, where block K represents seventy-five IDs and block L represents 100 IDs. It should be understood that the blocks can be allocated per 100 IDs. For example, blocks D and E together represent 100 IDs and blocks J and K together represent 100 IDs.

It should be understood that the blocks A-L illustrated in FIG. 2 are for illustration only. Some implementations of the histogram 200 may not explicitly include the blocks A-L, which are included in FIG. 2 for ease of illustrating the allocation as described herein.

The data trainer 130 executes a data training environment and includes an allocator 132 (e.g., an allocation module, component, or apparatus), a ML model 134, and a prediction generator 136 (e.g., a prediction generating module, component, or apparatus). In some examples, the data trainer 130 is referred to as an agent, such as a second agent. The data trainer 130 executes a training operation of the incoming data that is collected by the data receiver 124 and illustrated by the histogram generated by the histogram generator 126. In some implementations, the execution of the data trainer 130 is event driven. For example, the operations executed by the data collector 120 and the data trainer 130 are scheduled together and are in sync. In some implementations, the data trainer 130 begins its execution upon the conclusion of the data collector 120 operation. In other implementations, the data trainer 130 begins its execution upon a particular portion of the operation of the data collector 120 concluding, for example fifty percent of the data collector 120 operation concluding.

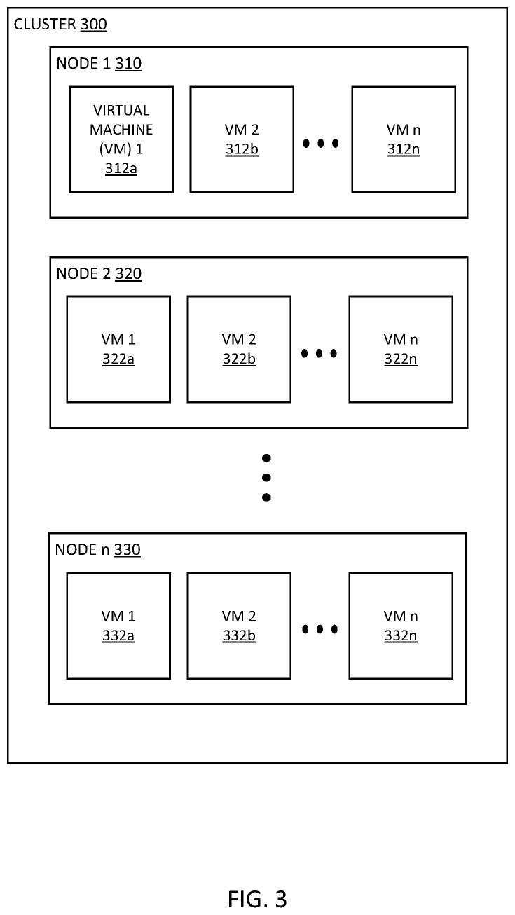

The allocator 132 dynamically shards the partitioned incoming data to one or more nodes according to the partitioning schema file generated by the partitioner 122. Exemplary sharding is based on the time-series nature of the incoming data, and results in efficiencies for training the ML model. As illustrated in FIG. 3, each of the one or more nodes includes at least one VM, also referred to herein as a worker, working node, training worker, and the like. As referenced herein, dynamic sharding refers to assigning an optimal number of working nodes to each region (e.g., geographical region), or source of the incoming data, using the partitioning schema file illustrated by the histogram 200. For example, FIG. 3 illustrates a cluster 300 that includes multiple nodes, such as node 1 310, node 2 320, and node n 330. It should be understood that a cluster 300 can include any suitable number of nodes without departing from the scope of the present disclosure. Each node includes one or more VMs, or worker nodes. The worker nodes can be executed locally on the respective node, in the cloud, or anywhere suitable for executing a VM. As shown in FIG. 3, node 1 310 includes a VM 1 312a, a VM 2 312b, and a VM n312n, node 2 320 includes a VM 1 322a, a VM 2 322b, and a VM n 322n, and node n 330 includes a VM 1 330a, a VM 2 330b, and a VM n 330n. Each node can include any suitable number of VMS without departing from the scope of the present disclosure.

The allocator 132 dynamically shards the partitioned incoming data illustrated by the histogram 200 to the one or more nodes illustrated in FIG. 3 in order to optimally balance the load for training by the ML model 134 discussed in greater detail below. For example, the allocator 132 utilizes the respective sources of the incoming data and breaks down the incoming data to a manageable size for analysis and processing by different worker nodes. The allocator 132 then allocates each of the VMs to the portions of the partitioned incoming data that was dynamically sharded to one of the nodes.

In some implementations, the dynamic sharding to be applied is adjusted at the runtime of the particular rolling window. For example, the dynamic sharding can be adjusted at the runtime in response to data being received from more IDs than expected, data being received from fewer IDs than expected, additional nodes or VMs being available than expected, fewer nodes or VMs being available than expected, to enable predictions produced by nodes to be pushed to external data source in parallel and reduce work that needs to be accomplished in case of node failure, or any other suitable reason. In some implementations, this also ensures the system 100 utilizes a minimal or reduced number of resources for training and utilizes those resources at full capacity for minimal or reduced costs.

In one implementation, the allocator 132 allocates the VMs of a particular node to a particular source of the incoming data. For example, the allocator 132 allocates node 1 310 to source 1 152, allocates node 2 320 to source 2 154, and allocates node n 330 to source 3 156. In this example, the entirety of blocks A-C are allocated to node 1 310, the entirety of blocks F-I are allocated to node 2 320, and block L is allocated to node n 330. However, none of blocks D, E, J, and K include exactly 100 IDs, so allocating VMs of a node to these blocks could result in an imbalanced workload. For example, if a VM was allocated to each of blocks A-D, the VM allocated to block D would take approximately half as long to process its data than the VMs allocated to blocks A-C due to block D including half as many IDs.

In some implementations, the nodes and VMs are allocated to the incoming data using a particular schema, for example a schema comprising {‘rank’:‘int64’, sources’:‘str’, ‘source_rank’:‘int64’, source_worker_count’:‘int64’} to evenly assign the IDs across the available worker nodes for the processing to occur in the training step by the ML model 134. For example, the allocator 132 identifies a total number of VMs available and a total number of IDs for which incoming data was received for processing by the data trainer 130. The allocator 132 can then walk through the histogram 200 and assign a particular VM to a particular region, e.g., a particular segment of the IDs received from a particular source.

In some implementations, the allocator 132 utilizes a hash function to assign the IDs to a particular VM. For example, the allocator 132 converts a first character or a first two characters of each ID received in the incoming data to a 16-bit interpretation and modifies that with the number of worker nodes assigned to that region. For example, the modification of lambda vmssid: (int(vmssid[0:2], 16) % source_workers_count)==source_worker_rank corresponds to a source of incoming data that has three worker nodes assigned to it, such that worker_0, worker_1, and worker_2 each are allocated a balanced amount of IDs for which to process the data. This modification extracts the first two characters of the VMSS ID, which is a GUID and therefore contains only hexadecimal characters, converts these two characters to an alphanumeric number using base 16, divides the result of the conversion by the number of workers, and compares the remainder of the division to the number of current workers and returns true if the numbers match. For example, the number using base 16 can be a number between zero and fifty-five.

In some implementations, a single node is allocated to each source such that no VMs of the node are allocated to incoming data received from multiple sources. In this implementation, node 1 310 is allocated to the incoming data received from source 1 152. In some examples, the allocator 132 then allocates VM 1 312a to process the data of the IDs identified as block A, VM 2 312b to process the data of the IDs identified as block B, a third VM to process the data of the IDs identified as block C, and VM n 312n to process the data of the IDs identified as block D. This allocation process balances the processing workload using a small amount of VMs.

In another example, the allocator 132 allocates VM 1 312a to process the data of half of the IDs identified as block A and VM 2 312b to process the data of the other half of the IDs identified as block A, third and fourth VMs to process the data of the IDs identified as block B, fifth and sixth VMs to process the data of the IDs identified as block C, and a seventh VM n 312n to process the data of the IDs identified as block D. This allocation process more evenly balances the processing workload, but requires the use of additional VMs.

In another implementation, the allocator 132 then allocates VM 1 312a to process the data of the IDs identified as block A, VM 2 312b to process the data of the IDs identified as block B, a third VM to process the data of the IDs identified as block C, and VM n 312n to process the data of the IDs identified as block D and the data of the IDs identified as block E. The allocator 132 allocates the VMs of the node 2 to blocks F-I including the data associated with IDs received from source 2 154, allocates VM n 322n to blocks J and K, and allocated VM 1 332a of node n 330 to block L. This allocation process balances the processing workload evenly among the VMs of a node, but requires some VMs to process the data received from more than one source.

In another implementation, rather than allocating VMs per node, the allocator 132 considers a node as analogous to a VM and allocates multiple processes within the same VM to do the same work.

The ML model 134 controls the allocated VMs in the cluster 300 to process the received incoming data stored in the data storage 140 in parallel as part of the execution of one or more ML models. To process the received incoming data, the ML model 134 recreates, or reconstructs, a time-series by appending consecutive sequences of the rolling window. By recreating the time-series, the ML model 134 generates a requisite time frame of data for processing and to generate a prediction or forecast. In addition to appending the new sequence of the rolling window to previously-obtained data to reconstruct the time-series, the ML model 134 recycles any data that was previously included in the time-series but is now outside of the scope of the time-series. For example, the sequence that was the first, e.g., oldest, sequence in the most recent iteration of the time-series will, upon the appending of the new sequence to the updated time-series, become the first sequence to be outside of the scope of the updated time-series.

In some implementations, the execution of the ML model 134 is specific to each source for which the incoming data is received. For example, a ML model is executed for the incoming data received from source 1 152 by its allocated VMs, a ML model is executed for the incoming data received from source 2 154 by its allocated VMs, and a ML model is executed for the incoming data received from source 3 156 by its allocated VMs. In some implementations, the ML model for the incoming data received from each source is the same. For example, the VM 1 332a executes a ML model on the incoming data associated with the IDs included in block L that is the same ML model the VM 1 312a executes on the incoming data associated with the IDs included in block A. In other implementations, the ML model executed for the incoming data received from each source is different. For example, the VM 1 332a executes a ML model on the incoming data associated with the IDs included in block L that is different than the ML model the VM 1 312a executes on the incoming data associated with the IDs included in block A.

The prediction generator 136 generates a prediction, or forecast, based on the trained ML model 134. In some implementations, the generated prediction or forecast is specific to each source of the received incoming data based on a single rolling window data transfer. For example, the prediction generator 136 generates a first prediction corresponding to the source 1 152, a second prediction corresponding to the second 2 154, and a third prediction corresponding to the source 3 156.

For example, as described herein, each of the different sources can correspond to a different type of data. In one example, the source 1 152 provides data corresponding to a percentage of CPU usage for each VMSS ID, the source 2 154 provides data corresponding to weather for a particular region, such as temperatures or precipitation, and the source 3 156 provides data corresponding to screen time spent on a mobile electronic device or devices. As described herein, for a single rolling window data transfer, the respective data is collected by the data collector 120 and a histogram is generated, the data is stored in the data storage 140, and the data trainer 130 allocates VMs to the respective data and processes the data via the trained ML model. Based on the trained ML model 134 for each respective data, the prediction generator 136 generates a prediction for percentage of CPU usage for each VMSS ID in source 1 152, generates a weather forecast including a temperature and precipitation prediction for the location corresponding to source 2 154, and generates a screen time prediction for the mobile electronic device or devices corresponding to the source 3 156.

The data storage 140 is an intermediary storage location. In some implementations, the data storage 140 is an object storage solution based in the cloud and is optimized for storing large amounts of either structured or unstructured data. In some implementations, the data storage 140 is a hard drive. Unstructured data refers to data that does not adhere to a particular data model or definition, for example text or binary data. In other implementations, the data storage 140 is locally based on particular hardware, for example a memory. The data storage 140 stores the received incoming data, or compressed files containing the received incoming data, that is collected by the data collector 120 for processing by the data trainer 130. In some implementations, the histogram generated by the histogram generator 126 is stored in the data storage 140.

Each of the source 1 152, the source 2 154, and the source 3 156 refers to a different source of the data that is received by the data collector 120. In some implementations, each of the source 1 152, the source 2 154, and the source 3 156 transmit a similar type of data, such as weather data, percentage of resource usage, etc. For example, each of the source 1 152, the source 2 154, and the source 3 156 can transmit a similar type of data but from a different region or location. In some implementations, each of the source 1 152, the source 2 154, and the source 3 156 transmit different types of data.

Each of the source 1 152, the source 2 154, and the source 3 156 is configured to receive a query from the data receiver 124 and transmit the respective data in response to receiving the query. In some implementations, rather than transmitting data in response to a query, the sources are configured to transmit the respective data on a fixed schedule, for example on every hour or at the same time each day.

The computing environment 110 further includes at least one processor 160, a user interface 170, and a memory 180 that includes computer-executable instructions 182. The processor 160 includes any quantity of processing units and is programmed to execute the computer-executable instructions 106. The computer-executable instructions 182 are executed, or performed, by the processor 160, executed by multiple processors within the computing environment 110, or executed by a processor external to the computing environment 110. In some examples, the processor 160 is programmed to execute computer-executable instructions 182 such as those illustrated in the figures described herein, such as FIGS. 2-6.

The user interface 170 includes a graphics card for displaying data to a user and receiving data from the user. The user interface 170 can also include computer-executable instructions, for example a driver, for operating the graphics card. Further, the user interface 170 can include a display, for example a touch screen display or natural user interface, and/or computer-executable instructions, for example a driver, for operating the display. The user interface 170 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing environment 110 in one or more ways.

The memory 180 includes any quantity of media associated with or accessible by the computing environment 110. In some examples, the memory 180 is internal to the computing environment 110. In other examples, the memory 180 is external to the computing environment 110 or both internal and external to the computing environment 110. For example, the memory 180 can include both a memory component internal to the computing environment 110 and a memory component external to the computing environment 110. The memory 180 stores data, such as one or more applications. The applications, when executed by the processor 160, operate to perform various functions on the computing environment 110. The applications can communicate with counterpart applications or services, such as the data collector 120, the data trainer 130, and the data storage 140.

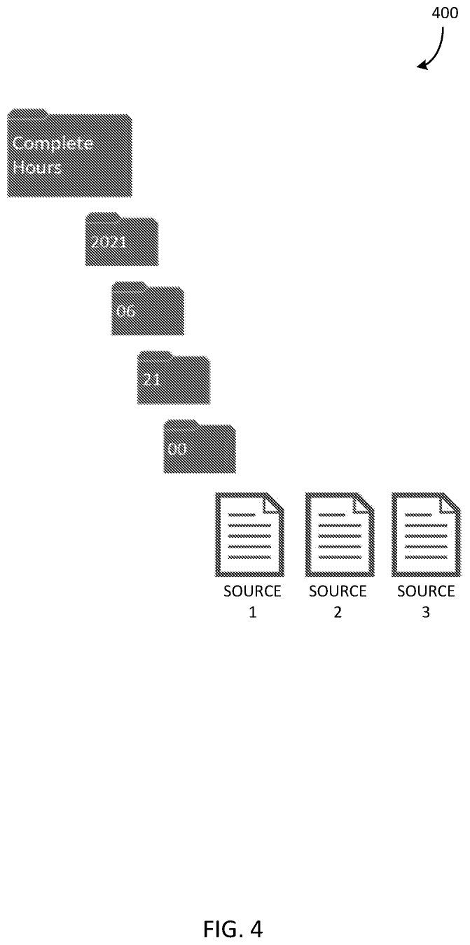

FIG. 4 illustrates a rolling window data collection folder structure. The rolling window data collection folder structure illustrated in FIG. 4 is a collection folder structure for collecting a complete hours' worth of data within a rolling window data transfer.

As shown in FIG. 4, the full hour of data for each particular source is stored together. FIG. 4 illustrates a folder for complete hours that includes a subfolder for the year, another subfolder for the month, another subfolder for the day, and another subfolder for the hour. According to this folder structure, or hierarchy, the source 1 152 file is named Source1-2021-06-21-00.csv, the source 2 154 file is named Source2-2021-06-21-00.csv, and the source 3 156 file is named Source 3-2021-06-21-00.csv. In other words, separate source files are stored in the 2021-06-21.00 folder. In the next increment of the rolling window data transfer, the folder structure would show 2021-06-21-01, and so forth.

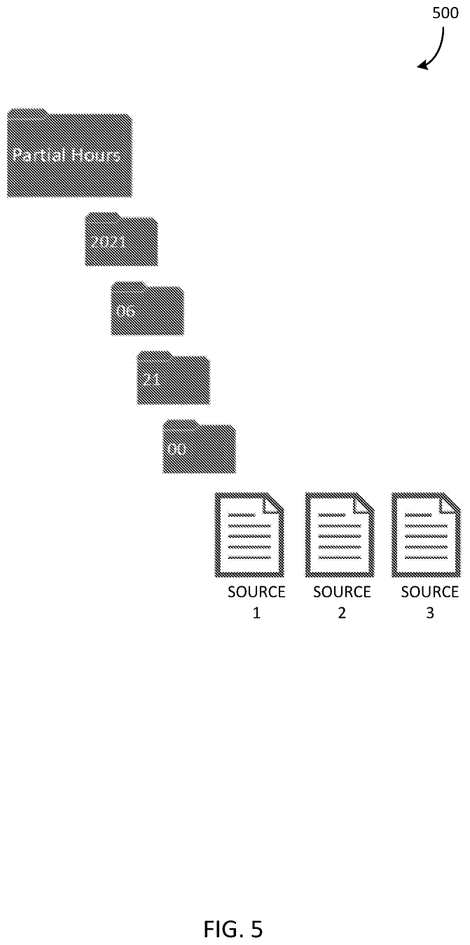

In some implementations, the data collector 120 is controlled to collect data from the sources in a partial interval, rather than on the hour as performed for most iterations. For example, the data collector 120 queries the sources to collect the data at a time that returns only partial hour data, rather than the entire hour increment. For example, FIG. 5 illustrates a rolling window data collection folder structure for collecting a partial hours' worth of data within a rolling window data transfer.

As shown in FIG. 5, the partial hour of data for each particular source is stored together. FIG. 5 illustrates a folder for partial hours that includes a subfolder for the year, another subfolder for the month, another subfolder for the day, and another subfolder for the hour. According to this folder structure, or hierarchy, the source 1 152 file is named Source1-2021-06-21-00.csv, the source 2 154 file is named Source2-2021-06-21-00.csv, and the source 3 156 file is named Source 3-2021-06-21-00.csv. In other words, separate source files are stored in the 2021-06-21.00 folder. In the next increment of the rolling window data transfer, the folder structure would show 2021-06-21-01, and so forth. Upon the complete hour of data being collected, the full hour is stored as shown in FIG. 4 and the folder for the partial hours of data can be recycled.

As described herein, in some implementations the data collector 120 compresses the data prior to transferring the incoming data to the data storage 140. In these examples, the entire hour subfolder is compressed and transferred to the data storage 140 for storage and retrieval by the data trainer 130. For example, a compressed folder corresponding to the example illustrated in FIG. 4 is named CompleteHours-2021-06-21-00.zip and includes each of the 2021-06-21-00.csv, Source2-2021-06-21-00.csv, and Source3-2021-06-21-00.csv files.

It should be understood that in some implementations, a new ID is included in a rolling window data transfer that has not been previously received in previous windows. In such implementations, for the new ID, the requisite time-series cannot be generated with previous data because data corresponding to the new ID has not been previously received. In these implementations, the data collector 120 flags the new ID and re-queries the particular source in which the new ID was detected for the previous data.

In some implementations, a particular timeframe of sequences can be missing from a time-series. For example, a service that is turned on and utilizing the systems and methods presented herein can then be turned off and later back on again, resulting in a gap of missing data while the service was turned off. In this example, the data collector 120 re-queries the particular source for the missing data and backfills the data once the incoming data is received so that the full time-series can be reconstructed.

In some implementations, the source may not return the data immediately in response to a query from the data collector 120. In these implementations, the data collector 120 re-queries the source at a later point in time and backfills the data once the incoming data is received so that the full time-series can be reconstructed.

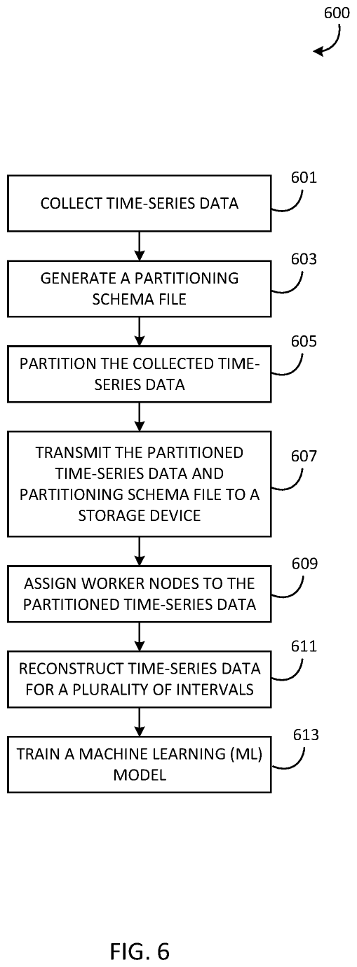

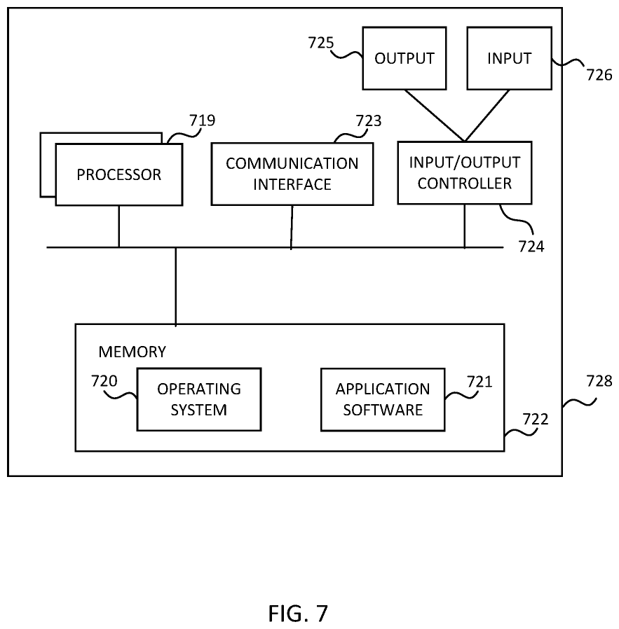

FIG. 6 illustrates a method for performing a rolling data transfer and time-series training according to an example. The method 600 illustrated in FIG. 6 is for illustration only. Other examples of the method 600 can be used without departing from the scope of the present disclosure. The method 600 can be implemented by one or more components of the system 100 illustrated in FIG. 1, such as the components of the computing apparatus 718 described in greater detail below in the description of FIG. 7. In particular, the steps of the method 600 can be executed by the processor 719 of the computing apparatus 718.

The method 600 begins by the data collector 120 collecting time-series data corresponding to an interval of time in operation 601. As referenced herein, in some examples the data collector 120 is referred to as a first agent. In some implementations, the data collector 120 collects the time-series data in a rolling window data transfer from one or more sources, for example source 1 152, source 2 154, and source 3 156 as described herein. In some implementations, the time-series data is associated with a quantity of identifiers (IDs) collected from one or more sources. In some implementations, the data collector 120 collects raw data and then stores intermediate calculations. The intermediate calculations are stored using a structure to enable subsequent iterations of training to re-use the collected raw data.

In operation 603, the data collector 120 generates a partitioning schema file for the collected time-series data. The partitioning schema file is a plan for how the collected time-series data is to be stored for accessing and using by a second agent, for example the data trainer 130. The partitioning schema file can include folder structures and hierarchies for the collected time-series data from each individual source.

In operation 605, the data collector 120 partitions the collected time-series data according to the partitioning schema file based on metadata characteristics of the time-series data. The metadata characteristics include one or more of: the time interval when the time-series data was collected or a predicted granularity of a rolling window of time. In some implementations, the data collector 120 generates a histogram illustrating the partitioned time-series data according to the partitioning schema file. The histogram illustrates the quantity of IDs collected from each of the one or more sources.

In operation 607, the data collector 120 transmits the partitioned time-series data and the partitioning schema file to a storage device, for example the data storage 140. The storage device stores time-series data collected during various intervals of time, including previous intervals of time. In some implementations, the storage device is a hard drive.

In operation 609, the data trainer 130 assigns a plurality of worker nodes to the partitioned time-series data stored in the storage device based at least in part on the partitioning schema file also stored in the storage device. For example, the data trainer 130 dynamically shards the partitioned time-series data to one or more nodes according to the generated partitioning schema file, for example node 1 310, node 2 320, and node n 330. As described herein, each of the one or more nodes includes at least one of the plurality of worker nodes, for example the VMs 312a-312, 322a-322n, and 332a-332n. The combination of partitioning the time-series data and assigning particular worker nodes to the partitioned time-series data reduces the data to be transferred to each node for processing, enabling efficient recreation and processing of time-series data. In some implementations, the assignment of the plurality of worker nodes is based at least in part on the generated histogram.

In operation 611, each of the assigned plurality of worker nodes reconstructs a sequence of time-series data for a plurality of intervals of time from the storage device. The plurality of intervals includes both the partitioned time-series data and the time-series data collected during the previous intervals of time that are stored in the storage device. In some implementations, as described herein, the assigned plurality of worker nodes concatenates, or appends, consecutive sequences of the time-series data collected during the previous intervals of time to reconstruct the full sequence of time-series data for processing.

In operation 613, the assigned plurality of worker nodes trains, in parallel, a ML model using the reconstructed sequence of time-series data. In some implementations, the assigned plurality of worker nodes trains different ML models depending on the source of the time-series data. For example, worker nodes assigned to time-series data collected from source 1 152 may train a different ML model than worker nodes assigned to time-series data collected from source 2 154 if source 1 152 contains a different type of data than source 2 154.

A prediction is generated based at least in part on the trained ML model. In some implementations, the generated prediction is specific to the source of the time-series data from which it was collected. For example, a different prediction is generated by the worker nodes assigned to the time-series data collected from source 1 152 than by the worker nodes assigned to the time-series data collected from source 2 154.

### Exemplary Operating Environment

The present disclosure is operable with a computing apparatus according to an example as a functional block diagram 700 in FIG. 7. In an example, components of a computing apparatus 718 may be implemented as a part of an electronic device according to one or more examples described in this specification. For example, the computing apparatus 718 can be the computing environment 110 illustrated in FIG. 1. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. Platform software comprising an operating system 720 or any other suitable platform software may be provided on the apparatus 718 to enable application software 721 to be executed on the device. In some implementations, the one or more processors 719 is the at least one processor 160 and the memory 722 is the memory 180.

Computer executable instructions may be provided using any computer-readable media that are accessible by the computing apparatus 718. Computer-readable media may include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that the storage may be distributed or located remotely and accessed via a network or other communication link (e.g., using a communication interface 723).

In some examples, the computer-readable media includes instructions that, when executed by the processor 719, execute instructions to control one or more of the partitioner 122, the data receiver 124, the histogram generator 126, the allocator 132, the ML model 134, the prediction generator 136, and the data storage module140.

The computing apparatus 718 may comprise an input/output controller 724 configured to output information to one or more output devices 725, for example a display or a speaker, which may be separate from or integral to the electronic device. For example, the output device 725 can be the user interface 150. The input/output controller 724 may also be configured to receive and process an input from one or more input devices 726, for example, a keyboard, a microphone, or a touchpad. In one example, the output device 725 may also act as the input device. An example of such a device may be a touch sensitive display that functions as the user interface 170. The input/output controller 724 may also output data to devices other than the output device, e.g., a locally connected printing device. In some examples, a user may provide input to the input device(s) 726 and/or receive output from the output device(s) 725.

The functionality described herein can be performed, at least in part, by one or more hardware logic components. According to an example, the computing apparatus 718 is configured by the program code when executed by the processor 719 to execute the examples of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Additional Examples

An example system includes at least one processor and at least one memory comprising computer program code. The computer program code, when executed by the at least one processor, causes the at least one processor to collect time-series data corresponding to an interval of time, generate a partitioning schema file for the collected time-series data, partition the collected time-series data according to the partitioning schema file based on metadata characteristics of the time-series data, transmit the partitioned time-series data and the partitioning schema file to a storage device, the storage device storing time-series data collected during previous intervals of time, assign a plurality of worker nodes to the partitioned time-series data based at least in part on the partitioning schema file stored in the storage device, reconstruct, by the assigned plurality of worker nodes, a sequence of time-series data for a plurality of intervals of time from the storage device, the plurality of intervals including the partitioned time-series data and the time-series data collected during the previous intervals of time, and train, by the assigned plurality of worker nodes in parallel, a machine learning (ML) model using the reconstructed sequence of time-series data.

An example computerized method includes collecting, by a first agent implemented on at least one processor, time-series data corresponding to an interval of time, generating, by the first agent, a partitioning schema file for the collected time-series data, partitioning, by the first agent, the collected time-series data according to the partitioning schema file based on metadata characteristics of the time-series data, transmitting, by the first agent, the partitioned time-series data and the partitioning schema file to a storage device, the storage device storing time-series data collected during previous intervals of time, assigning, by a second agent implemented on the at least one processor, a plurality of worker nodes to the partitioned time-series data based at least in part on the partitioning schema file stored in the storage device, reconstructing, by the assigned plurality of worker nodes, a sequence of time-series data for a plurality of intervals of time from the storage device, the plurality of intervals including the partitioned time-series data and the time-series data collected during the previous intervals of time, and training, by the assigned plurality of worker nodes in parallel, a machine learning (ML) model using the reconstructed sequence of time-series data.

Example one or more computer storage media have computer-executable instructions that, upon execution by a processor, cause the processor to time-series data corresponding to an interval of time, generate a partitioning schema file for the collected time-series data, partition the collected time-series data according to the partitioning schema file based on metadata characteristics of the time-series data, transmit the partitioned time-series data and the partitioning schema file to a storage device, the storage device storing time-series data collected during previous intervals of time, assign a plurality of worker nodes to the partitioned time-series data based at least in part on the partitioning schema file stored in the storage device, reconstruct, by the assigned plurality of worker nodes, a sequence of time-series data for a plurality of intervals of time from the storage device, the plurality of intervals including the partitioned time-series data and the time-series data collected during the previous intervals of time, and train, by the assigned plurality of worker nodes in parallel, a machine learning (ML) model using the reconstructed sequence of time-series data.

Alternatively, or in addition to the other examples described herein, examples include any combination of the following:

wherein the partitioned time-series data is associated with a quantity of identifiers (IDs) collected from one or more sources;
dynamically sharding the partitioned time-series data to one or more nodes according to the generated partitioning schema file, each of the one or more nodes including at least one of the plurality of worker nodes;
allocating the plurality of worker nodes to the partitioned time-series data;
generate a histogram illustrating the partitioned time-series data according to the partitioning schema file;
assign the plurality of worker nodes to partitioned time-series data based at least in part on the generated histogram;
generate a prediction based at least in part on the trained ML model:
wherein the metadata characteristics include one or more of the time interval or a predicted granularity of a rolling window of time; and recreate the sequence of the time-series data by concatenating consecutive sequences of the time-series data collected during the previous intervals of time.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
at least one processor; and
at least one memory comprising computer program code, the at least one memory and the computer program code configured to, with the at least one processor, cause the at least one processor to:
collect time-series data corresponding to an interval of time,
generate a partitioning schema file for the collected time-series data,
partition the collected time-series data according to the partitioning schema file based on metadata characteristics of the time-series data,
transmit the partitioned time-series data and the partitioning schema file to a storage device, the storage device storing time-series data collected during previous intervals of time, and
assign a plurality of worker nodes to the partitioned time-series data based at least in part on the partitioning schema file stored in the storage device,
wherein each of the assigned plurality of worker nodes is configured to reconstruct a sequence of time-series data for a plurality of intervals of time from the storage device, the plurality of intervals including the partitioned time-series data and the time-series data collected during the previous intervals of time, and
wherein each of the assigned plurality of workers is configured to train, in parallel, a machine learning model using the reconstructed sequence of time-series data.

2. The system of claim 1, wherein:
the partitioned time-series data is associated with a quantity of identifiers collected from one or more sources.

3. The system of claim 1, wherein the processor is configured to assign the plurality of worker nodes to the partitioned time-series data at least by:
dynamically sharding the partitioned time-series data to one or more nodes according to the generated partitioning schema file, each of the one or more nodes including at least one of the plurality of worker nodes, and
allocating the plurality of worker nodes to the partitioned time-series data.

4. The system of claim 1, wherein the processor is further configured to:
generate a histogram illustrating the partitioned time-series data according to the partitioning schema file; and
assign the plurality of worker nodes to partitioned time-series data based at least in part on the generated histogram.

5. The system of claim 1, wherein the processor is further configured to:
generate a prediction based at least in part on the trained machine learning model.

6. The system of claim 1, wherein the metadata characteristics include one or more of the time interval or a predicted granularity of a rolling window of time, and wherein the processor is further configured to recreate the sequence of the time-series data by concatenating consecutive sequences of the time-series data collected during the previous intervals of time.

7. A computer-implemented method comprising:
collecting, by a first agent implemented on at least one processor, time-series data corresponding to an interval of time,
generating, by the first agent, a partitioning schema file for the collected time-series data,
partitioning, by the first agent, the collected time-series data according to the partitioning schema file based on metadata characteristics of the time-series data,
transmitting, by the first agent, the partitioned time-series data and the partitioning schema file to a storage device, the storage device storing time-series data collected during previous intervals of time,
assigning, by a second agent implemented on the at least one processor, a plurality of worker nodes to the partitioned time-series data based at least in part on the partitioning schema file stored in the storage device,
reconstructing, by the assigned plurality of worker nodes, a sequence of time-series data for a plurality of intervals of time from the storage device, the plurality of intervals including the partitioned time-series data and the time-series data collected during the previous intervals of time, and
training, by the assigned plurality of worker nodes in parallel, a machine learning model using the reconstructed sequence of time-series data.

8. The computer-implemented method of claim 7, wherein:
the partitioned time-series data is associated with a quantity of identifiers collected from one or more sources.

9. The computer-implemented method of claim 7, wherein assigning the plurality of worker nodes to the partitioned time-series data further comprises:
dynamically sharding the partitioned time-series data to one or more nodes according to the generated partitioning schema file, each of the one or more nodes including at least one of the plurality of worker nodes, and
allocating the plurality of worker nodes to the partitioned time-series data.

10. The computer-implemented method of claim 7, further comprising:
generating, by the first agent, a histogram illustrating the partitioned time-series data according to the partitioning schema file; and
assigning, by the second agent, the plurality of worker nodes to partitioned time-series data based at least in part on the generated histogram.

11. The computer-implemented method of claim 7, wherein the metadata characteristics include one or more of a slot of time or a predicted granularity of a rolling window of time, and wherein recreating the sequence of the time-series data further comprises concatenating consecutive sequences of the time-series data collected during the previous intervals of time.

12. One or more computer-readable storage media comprising a plurality of instructions that, when executed by a processor, cause the processor to:
collect time-series data corresponding to an interval of time,
generate a partitioning schema file for the collected time-series data,
partition the collected time-series data according to the partitioning schema file based on metadata characteristics of the time-series data,
transmit the partitioned time-series data and the partitioning schema file to a storage device, the storage device storing time-series data collected during previous intervals of time, and
assign a plurality of worker nodes to the partitioned time-series data based at least in part on the partitioning schema file stored in the storage device,
wherein each of the assigned plurality of worker nodes is configured to reconstruct a sequence of time-series data for a plurality of intervals of time from the storage device, the plurality of intervals including the partitioned time-series data and the time-series data collected during the previous intervals of time, and
wherein each of the assigned plurality of worker nodes is configured to train, in parallel, a machine learning model using the reconstructed sequence of time-series data.

13. The one or more computer-readable storage media of claim 12, further comprising instructions that, when executed by the processor, cause the processor to:
dynamically shard the partitioned time-series data to one or more nodes according to the generated partitioning schema file, each of the one or more nodes including at least one of the plurality of worker nodes, and
allocate the plurality of worker nodes to the partitioned time-series data.

14. The one or more computer-readable storage media of claim 13, further comprising instructions that, when executed by the processor, cause the processor to:
generate a histogram illustrating the partitioned time-series data according to the partitioning schema file, and
assign the plurality of worker nodes to partitioned time-series data based at least in part on the generated histogram.

15. The one or more computer-readable storage media of claim 12, further comprising instructions that, when executed by the processor, cause the processor to:
generate a prediction based at least in part on the trained machine learning model.
